(19) United States
(12) Patent Application Publication
(10) Pub. No.: US 2007/0261576 A1
(43) Pub. Date: Nov. 15, 2007

(54) Reel-fed rotary printing press

(75) Inventors: Andreas Muller, Plauen (DE); Georg Riescher, Jossnitz (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/796,738

(22) Filed: Apr. 27, 2007

(30) Foreign Application Priority Data
Apr. 29, 2006 (DE) 10 2006 020 054.3

(51) Int. Cl. B41F 7/12; B41F 13/04

(52) U.S. Cl. 101/216

(57) ABSTRACT

A reel-fed rotary printing press including printing units for printing at least one web, wherein each printing unit includes a form cylinder with a circumference defining a circumferential direction and a length defining a longitudinal direction. The form cylinder can be lined with at least two broadsheet pages extending upright in the circumferential direction, and at least two broadsheet pages extending widthwise in the longitudinal direction. In order to produce tabloid products while maintaining their book structure, the form cylinder can also be lined with at least two tabloid pages extending upright in the circumferential direction, and at least two tabloid pages extending widthwise in the longitudinal direction.

### BACKGROUND OF THE INVENTION

1. Field of the Invention

The invention relates to a reel-fed rotary printing press with printing units for the printing of webs, wherein each printing unit contains a form cylinder each of which in circumferential direction and longitudinal direction can be lined with upright broadsheet pages or horizontal tabloid pages.

2. Description of the Related Art

U.S. Pat. No. 6,408,747 discloses a reel-fed rotary press with printing units on the form cylinders of which broadsheet pages or per broadsheet page two horizontal tabloid pages can be placed. The web printed by these printing units is longitudinally slit into strands which are longitudinally folded by means of folding funnels. In the event that these strands printed with tabloid pages are subsequently fed to a folding apparatus placed one against the other, the strands are cut into tabloid products and folded transversely so that a tabloid product is created, which, inserted into one another, contains the tabloid books of the strands individually folded longitudinally, wherein the transverse fold forms the back of the tabloid product being created. In the process, the book structure of the joined individual tabloid books is lost.

### SUMMARY OF THE INVENTION

It is the object of the invention with a reel-fed rotary printing press to create the possibility of manufacturing tabloid products while maintaining their book structure.

According to the invention, the form cylinder can be lined with several upright tabloid pages in either the circumferential direction or the longitudinal direction. Thanks to the upright arrangement of the tabloid pages on the form cylinder the back of the tabloid book to be produced is formed via the folding funnel during longitudinal folding. A transverse fold is no longer required. The tabloid books are obtained through transverse cutting. The entire product is formed by placing the strands against one another and if applicable through gathering through placement against one another so that the book structure is retained. In addition, upright allows more tabloid use to be arranged in circumference direction of the form cylinder with a concomitant production increase of books.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic perspective view of a 6/2 reel-fed rotary printing press, with a folding arrangement for broadsheet pages;

FIG. 1A is a schematic perspective view of a folding arrangement for tabloid pages;

FIG. 2 is a perspective view of a product of the machine according to FIG. 1 on lining with upright broadsheet pages;

FIG. 3 is a perspective view of a product of the machine according to FIG. 1A on lining with upright tabloid pages;

FIG. 4 is a plan view of the printing page lining of a form cylinder for a 3/2 reel-fed rotary printing press;

FIG. 4A is a plan view of a printing page lining of the form cylinder of FIG. 4 with 4/3 tabloid pages;

FIG. 5 is a plan view of the printing page lining of a form cylinder for a 4/2 reel-fed rotary printing press; and

FIG. 5A is a plan view of a printing page lining of the form cylinder of FIG. 5 with 6/3 tabloid pages.

### DETAILED DESCRIPTION OF THE PRESENTLY PREFERRED EMBODIMENTS

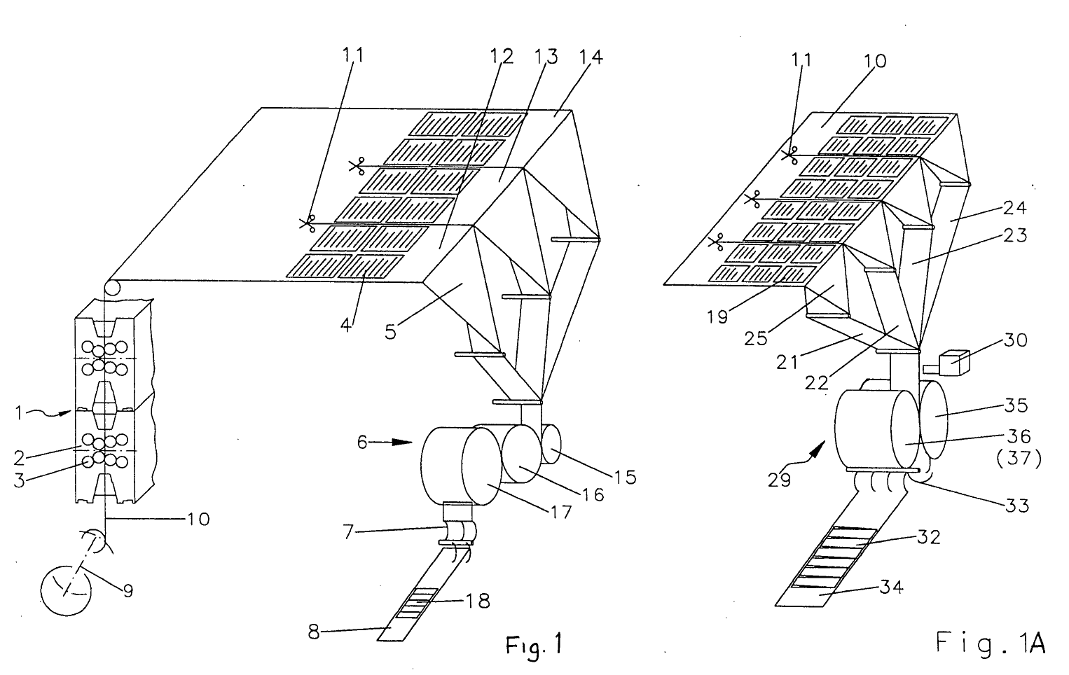

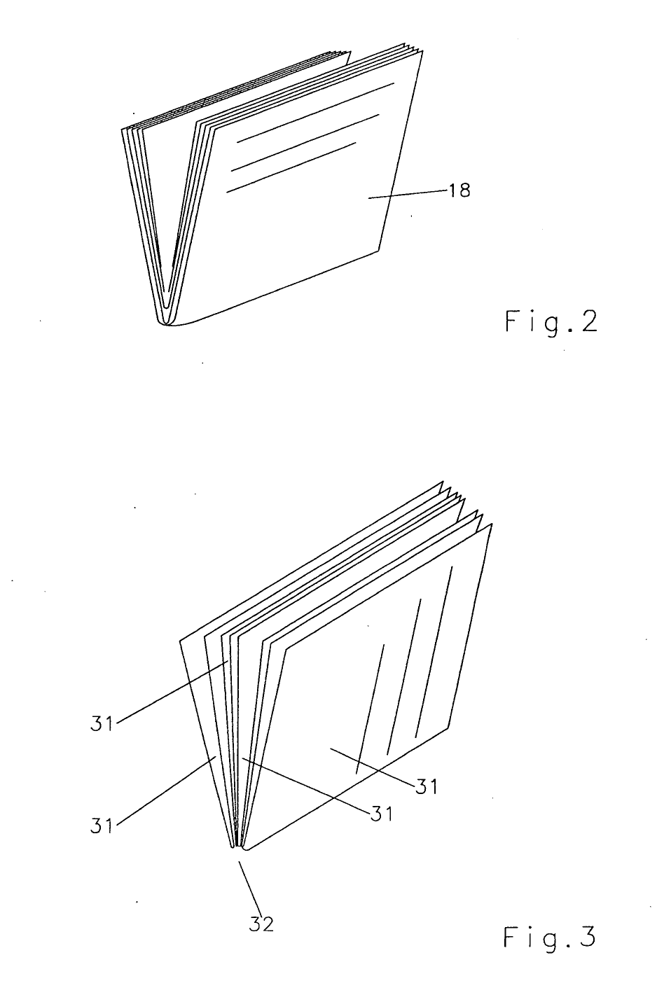

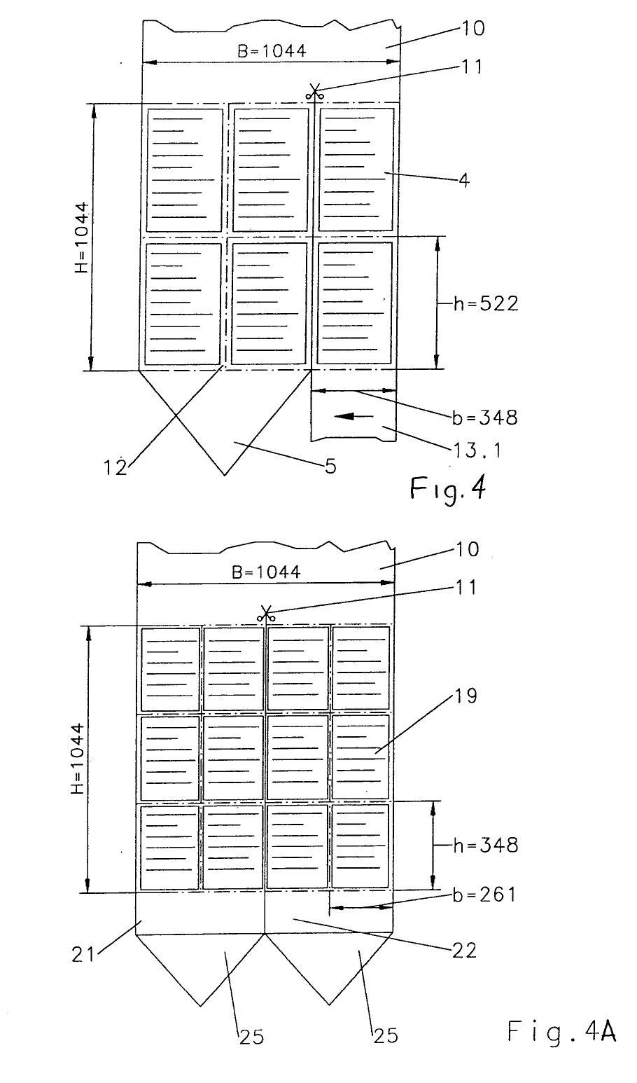

FIG. 1 shows a reel-fed rotary printing press having a so-called printing tower 1 with eight printing units 2, wherein each printing unit 2 contains a form cylinder 3. These are printing units for offset printing with which the expert is familiar, wherein, however, printing units for other printing processes may be employed as well. Each form cylinder 3 is lined in circumferential direction with two and in longitudinal direction with six upright broadsheet pages (print pages in broadsheet format) 4. The development of the form cylinder 3 is shown on a web 10. The form cylinder 3 carries two of the sets of print pages shown in FIG. 4, wherein the explanations for FIG. 4 follow later. This print page lining is a so-called 6/2 printing unit. The reel-fed rotary printing press furthermore has three folding funnels 5 arranged next to one another which are followed by a folding apparatus 6 and a paddle wheel 7 and a volume display 8. The web 10 unwound from an unwinding reel 9 is printed by the printing units 2 per form cylinder revolution on both sides with the broadsheet pages 4 shown on the web 10. The print pattern is transferred from the form cylinder 2 to a transfer cylinder and from the transfer cylinder to the web 10. In the exemplary embodiment two printing units 2 each work together according to the rubber-rubber principle, wherein the web 10 is passed through the transfer cylinders set against each other. The web 10 printed in this way is slit by means of two slitting devices 11 into three strands 12, 13, 14 each two broadsheet pages 4 wide, each of which is passed via a folding funnel 5 and longitudinally folded in the process. The longitudinally folded strands 12, 13, 14 are placed against one another and fed to the folding apparatus 6. The folding apparatus 6 is a 2:3:3 folding apparatus with a knife cylinder 15, a puncture folding knife cylinder 16 and a folding flap cylinder 17 with the mentioned diameter ratios. However, it could also be a 2:5:5 folding apparatus for example. In the folding apparatus 6 the strands 12, 13, 14 are cut into nicks which after transverse folding form the broadsheet product 18 shown in FIG. 2, which is discharged into the paddle wheel 7 and spread out on the volume display 8 scale-like. Ungathered, the broadsheet product contains 12 broadsheet pages, with gathering production, 24 broadsheet pages. In a manner known per se the form cylinder 3 can be lined per broadsheet page with two horizontal tabloid pages instead of the broadsheet pages 4, wherein the web 10 is likewise longitudinally slit into three strands in the manner described and the three strands slit longitudinally are passed via the three folding funnels 5 and are folded longitudinally and subsequently cut and cross-folded into tabloid products in the folding apparatus 6. Ungathered, two 24 page tabloid products and, gathered, a 48 page tabloid product can be produced per form cylinder rotation in this way.

Instead of with upright broadsheet pages 4, each form cylinder 3 can also be lined with upright tabloid pages (print pages in tabloid format) 19. The form cylinder 3 will then carry three upright tabloid pages 19 in circumferential direction and eight upright tabloid pages 19 in longitudinal direction. This is twice the arrangement of the set of tabloid pages 19 shown in FIG. 4 in longitudinal direction of the form cylinder 3. According to this arrangement the web 10 is now printed per form cylinder rotation on both sides with the 24 tabloid pages 19 each shown in FIG. 1A. The rotary printing press now presents itself as 8/3 tabloid page printing press. The height h and the width b of a broadsheet page 4 are in the ratio h/b=3/2. In the exemplary embodiment the height h=522 mm and the width b=348 mm. Six broadsheet pages 4 or 12 tabloid pages 19 are copied onto a print form. The tabloid pages 19 have a height h=348 mm and a width b=261 mm. The print form has the dimensions Height H×Width B=1044 mm×1044 mm. The form cylinder 3 carries two such print forms next to each other.

The web 10 printed with the upright tabloid pages 19 is slit by means of three slitting devices 11 into four strands 21 to 24 each two tabloid pages 19 wide. These strands 21 to 24 are each passed via a folding funnel 25 and folded longitudinally in the process. After this, the strands 21 to 24 are placed against one another and fed to a cutting unit 29. Prior to this, back gluing can additionally take place by means of a gluing unit 30, i.e. the fold backs are glued. The gluing unit 30 advantageously contains devices not shown in detail which apply the glue in strip form to individual strands 21 to 24. In the cutting unit 29 the strands 21 to 24 are cut into tabloid books 31 (FIG. 3). After this, four tabloid books 31 are each placed against one another and, if applicable, glued at the back, transferred into a paddle wheel 33 as a tabloid product 32 (FIG. 3) containing sixteen pages and subsequently spread out scale-like on a volume display 34. Here, the book structure is retained.

The cutting unit 29 for example is designed as a so-called 2:2 unit, i.e. it contains a knife cylinder 35 with two cutting knives on the circumference and a slot cylinder 36 with two cutting slots on the circumference. The knife cylinder 35 or the slot cylinder 36 can also be equipped as a gathering cylinder 37 (FIG. 1A) with a gathering device by means of which three successive tabloid books 31 per strand 21 to 24 can be gathered and then transferred into the paddle wheel 33. With this double gathering a 48 page tabloid product is produced. Thanks to the arrangement of three uses (print pages) in circumferential direction of the form cylinder 3 a production increase of books is possible. With 70 000 revolutions of the form cylinders 3 per hour, for example 210000 tabloid products 32 shown in FIG. 3 can be produced per hour. The page number of the broadsheet 18 or tabloid products 32 can be increased through gathering and/or increasing the number of the webs 10 and part-webs to be processed, for the purpose of which additional printing units 2 have to be employed. The webs 10 to be processed with the folding apparatus 6 or the cutting unit 29 can be produced in all application cases on one and the same printing units 2 and printing towers 1.

Instead of the folding funnels 5 in the processing of a web 10 printed with broadsheet pages 4, three of the folding funnels 25 can also be used by shifting these folding funnels 25 laterally and into the centers of the strands 12 to 14.

The number of pages of a tabloid product 32 with ungathered production can be changed in a stepping of two print pages, i.e. in a so-called two-page jump and, with gathered production, in the so-called six-page jump.

FIG. 4 shows the print page lining of the form cylinders 3 of a 3/2 reel-fed rotary printing press, presented in form of the development of the form cylinder 3 on the web 10. The form cylinder 3 in circumferential direction is lined with two and in longitudinal direction with three upright broadsheet pages 4. The broadsheet pages 4 have a height h=522 mm and a width b=348 mm, i.e. a ratio h/b=3/2. In contrast with the exemplary embodiment according to FIG. 1 the form cylinder is thus only equipped with one set of broadsheet pages 4. As for the rest, further processing of the web 10 is as described in FIG. 1. However, during longitudinal slitting by means of the slitting device 11, only two strands, 12, 13.1 are obtained wherein the strand 13.1 with the width of a broadsheet page 4 can be reversed onto the strand 12 (indicated with arrow) and runs via the folding funnel 5 together with strand 12.

Instead of with broadsheet pages 4 the form cylinder 3 can also be lined with upright tabloid pages 19, specifically with three upright tabloid pages 19 in circumferential direction and 4 upright tabloid pages 19 in longitudinal direction, as shown in FIG. 4A. For further processing, the web 10 printed with the tabloid pages 19 is slit with the longitudinal slitting device 11 into the two strands 21 and 22 each two tabloid pages 19 wide which, as described with the exemplary embodiment according to FIG. 4A, are each folded longitudinally by way of a folding funnel 25 and further processed. The tabloid pages 19 have a height h=348 mm and a width b=261 mm. A print form carrying the broadsheet pages 4 or the tabloid pages 19 has a height H=1044 mm and a width B=1044 mm. The printing press lined with the tabloid pages 19 thus embodies a 4/3 tabloid printing press.

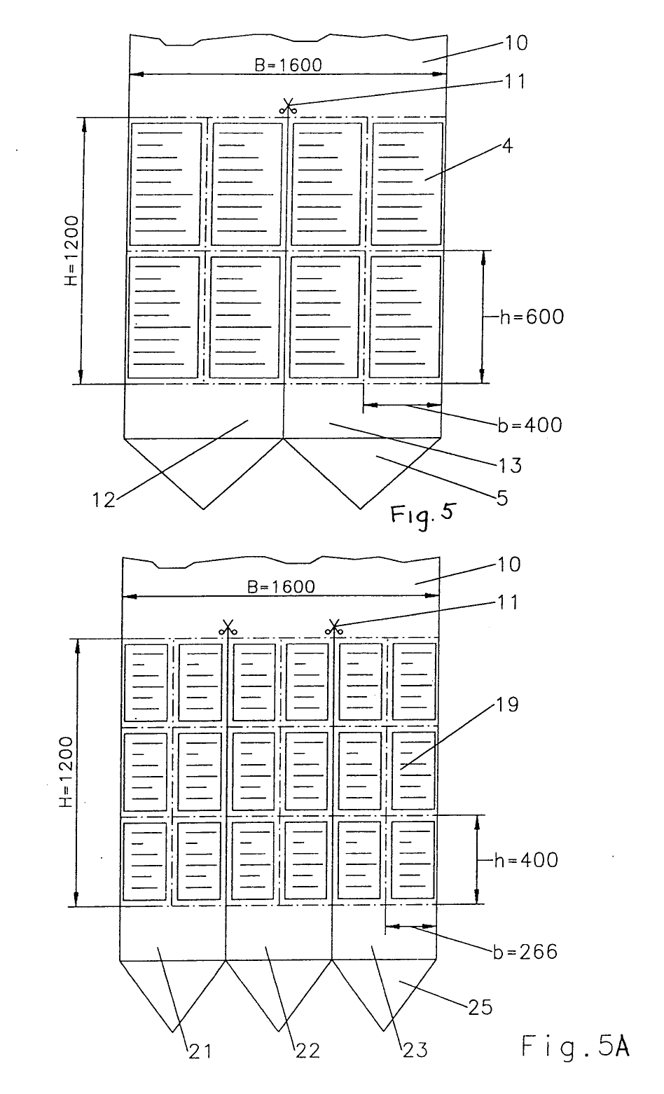

FIG. 5 shows the print page lining for a 4/2 rotary printing press, shown in form of the development of the form cylinder 3 on the web 10. The form cylinder 3 is lined in circumferential direction with 2 and in longitudinal direction with 4 upright broadsheet pages 4 having a height h=600 mm and a width b=400 mm. The strands 12, 13 created during longitudinal slitting of the web 10 by means of the longitudinal slitting device 11 each two broadsheet pages 4 wide are each passed via a folding funnel 5 and longitudinally folded and, as described in the exemplary embodiment according to FIG. 1, further processed.

Instead of with the broadsheet pages 4 the form cylinder 3 can also be lined with three upright tabloid pages 19 in circumferential direction and six upright tabloid pages 19 in longitudinal direction, as shown in FIG. 5A. Each of the tabloid pages 19 has a width b=266 mm and a height h=400 mm. It is thus a 6/3 tabloid lining. The web 10 printed with the tabloid pages 19 is slit into strands 21, 22, 23 by means of the longitudinal slitting devices 11 each to upright tabloid pages 19 wide, each of which is longitudinally folded by way of a folding funnel 25 and, as described in the exemplary embodiment according to FIG. 1, further processed. A printing form with this press has a height H=1200 mm and a width B=1600 mm. With a lining of the form cylinder 3 with horizontal tabloid pages 19 of the mentioned dimension a wide margin remains which can be cut off or used as pre-fold.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A reel-fed rotary printing press comprising printing units for printing at least one web,
wherein each said printing unit comprises a form cylinder with a circumference defining a circumferential direction and a length defining a longitudinal direction;
wherein said form cylinder can be lined with at least two broadsheet pages extending upright in the circumferential direction, and at least two broadsheet pages extending widthwise in the longitudinal direction; and
wherein said form cylinder can be lined with at least two tabloid pages extending upright in the circumferential direction, and at least two tabloid pages extending widthwise in the longitudinal direction.

2. The reel-fed rotary printing press of claim 1
wherein said form cylinder can be lined with two broadsheet pages extending upright in the circumferential direction, and three said broadsheet pages extending widthwise in the longitudinal direction, wherein each broadsheet page has a height to width ratio of 3/2; and
wherein said form cylinder can be lined with three tabloid pages extending upright in the circumferential direction, and four said tabloid pages extending widthwise in the longitudinal direction.

3. The reel-feed rotary press of claim 1
wherein said form cylinder can be lined with two broadsheet pages extending upright in the circumferential direction, and at least four said broadsheet pages extending widthwise in the longitudinal direction; and
wherein said form cylinder can be lined with three tabloid pages extending upright in the circumferential direction, and at least six said tabloid pages extending widthwise in the longitudinal direction.

4. The reel-fed rotary press of claim 3 further comprising:
means for slitting a web printed with at least four broadsheet pages extending widthwise into at least two strands, wherein each strand has a width of two broadsheet pages; and
at least two folding funnels for redirecting respective said strands; and
a folding apparatus which cuts and folds the strands to form broadsheet products.

5. The reel-fed rotary printing press of claim 3 further comprising:
means for slitting a web printed with at least six tabloid pages extending widthwise into at least three strands, wherein each strand has a width of two tabloid pages;
means for longitudinally folding the strands between printed pages;
at least three folding funnels for redirecting respective said strands; and
a cutting unit for cutting the folded strands into tabloid products.

6. The reel-fed rotary printing press of claim 5 wherein the cutting unit comprises a gathering cylinder which can gather tabloid books.
